(19) United States
(12) Patent Application Publication
(10) Pub. No.: US 2013/0152982 A1
(43) Pub. Date: Jun. 20, 2013

(54) DEVICE FOR CLEANING MEDICAL DEVICE

(71) Applicants: Toshio Tanaka, Sakai-shi (JP); Kenkichi Kagawa, Sakai-shi (JP); Makoto Iwakame, Settsu-shi (JP); Mitsuji Ohgami, Settsu-shi (JP); Takanori Ijitsu, Ashigarakami-gun (JP); Shinichi Takahira, Tokyo (JP); Eriko Ooshima, Tokyo (JP)

(72) Inventors: Toshio Tanaka, Sakai-shi (JP); Kenkichi Kagawa, Sakai-shi (JP); Makoto Iwakame, Settsu-shi (JP); Mitsuji Ohgami, Settsu-shi (JP); Takanori Ijitsu, Ashigarakami-gun (JP); Shinichi Takahira, Tokyo (JP); Eriko Ooshima, Tokyo (JP)

(73) Assignees: TERUMO KABUSHIKI KAISHA, Tokyo (JP); DAIKIN INDUSTRIES, LTD., Osaka-shi, Osaka (JP)

(21) Appl. No.: 13/819,211

(22) PCT Filed: Sep. 15, 2011
(86) PCT No.: PCT/JP2011/005215

§ 371 Date: Feb. 26, 2013

(30) Foreign Application Priority Data
Sep. 16, 2010 (JP) 2010-208249

(51) Int. Cl. B08B 7/00

(52) U.S. Cl. CPC B08B 7/0035
USPC 134/115 R

(57) ABSTRACT

A medical device cleaning device includes a washing tank, and an electrical discharge generator. An endoscope to be cleaned is housed in the washing tank, and immersed in wash water. An electrical discharge unit of the electrical discharge generator is placed in the washing tank, and immersed in the wash water. A direct-current power supply is connected to a pair of electrodes of the electrical discharge unit. When the direct-current power supply applies a voltage to the pair of electrodes, streamer discharge is performed between the pair of electrodes to produce hydrogen peroxide. The endoscope is sterilized in the washing tank by using the hydrogen peroxide produced by the streamer discharge.

### TECHNICAL FIELD

The present invention relates to devices for cleaning a medical device by immersing the medical device in cleaning fluid.

### BACKGROUND ART

Devices for cleaning a medical device by immersing the medical device in cleaning fluid have been conventionally known. For example, PATENT DOCUMENT 1 describes a cleaning device for an endoscope which is a medical device. The cleaning device includes a bottle in which a concentrated chemical solution is stored, and a washing tank for housing an endoscope. In the cleaning device, as cleaning fluid, cleaning fluid obtained by diluting the concentrated chemical solution in the bottle to a predetermined concentration is used, and the endoscope in the washing tank is cleaned with the cleaning fluid.

### CITATION LIST

Patent Document

PATENT DOCUMENT 1: Japanese Patent Publication No. 2010-119592

### SUMMARY OF THE INVENTION

### Technical Problem

Wash water containing hydrogen peroxide may be used for such a device for cleaning a medical device as described above. However, when such wash water is used, a predetermined concentration of a hydrogen peroxide solution needs to be appropriately added into a washing tank. Alternatively, hydrogen peroxide may be produced, for example, by electrolyzing water in the device. However, in a method in which hydrogen peroxide is produced by electrolysis, the rate of production of hydrogen peroxide is low, and thus, it may take significant time to obtain wash water possessing sufficient antimicrobial activity.

It is therefore an object of the present invention to provide a medical device cleaning device which enables easy production of wash water having high antimicrobial activity.

### SOLUTION TO THE PROBLEM

A first aspect of the invention is directed to a medical device cleaning device including: a washing tank (40) for housing a medical device (100), where the medical device (100) in the washing tank (40) is cleaned with wash water. An electrical discharge generator (50) including a pair of electrodes (51, 52) for inducing streamer discharge in the wash water, and a power supply (65) configured to apply a voltage to the pair of electrodes (51, 52) is provided to produce hydrogen peroxide in the wash water by streamer discharge between the pair of electrodes (51, 52), and the medical device (100) in the washing tank (40) is cleaned with the wash water containing the hydrogen peroxide produced by the streamer discharge between the pair of electrodes (51, 52).

In the first aspect of the invention, when the power supply (65) applies a voltage to the pair of electrodes (51, 52), streamer discharge is performed in the wash water. When streamer discharge is performed in the wash water, active species, such as hydroxyl radicals, are produced. The produced active species react with water molecules to produce a large amount of hydrogen peroxide. As a result, wash water containing hydrogen peroxide is easily obtained. The medical device (100) in the washing tank (40) is sterilized with the produced hydrogen peroxide.

According to a second aspect of the invention, in the first aspect of the invention, the pair of electrodes (51, 52) of the electrical discharge generator (50) may be placed in the washing tank (40).

In the second aspect of the invention, streamer discharge is performed between the pair of electrodes (51, 52) placed in the washing tank (40). In the washing tank (40), hydrogen peroxide is produced in the wash water stored therein, and the medical device (100) is sterilized with the produced hydrogen peroxide.

According to a third aspect of the invention, the medical device cleaning device of the first aspect of the invention may further include: an auxiliary tank (20) in which the cleaning fluid is stored, and in which the pair of electrodes (51, 52) of the electrical discharge generator (50) are placed; and a conduit (31) configured to carry the wash water containing the hydrogen peroxide from the auxiliary tank (20) into the washing tank (40).

In the third aspect of the invention, the pair of electrodes (51, 52) of the electrical discharge generator (50) are provided in the auxiliary tank (20) separate from the washing tank (40), and streamer discharge is performed in the wash water in the auxiliary tank (20). The wash water containing the hydrogen peroxide produced in the auxiliary tank (20) is fed from the auxiliary tank (20) through the conduit (31) into the washing tank (40). Then, the medical device (100) in the washing tank (40) is sterilized with hydrogen peroxide in the wash water.

According to a fourth aspect of the invention, in any one of the first through third aspects of the invention, the power supply may be formed by a direct-current power supply (65) configured to apply a direct-current voltage to the pair of electrodes (51, 52), and the electrical discharge generator (50) may include a current density concentration member (55) configured to increase a current density in a current path between the pair of electrodes (51, 52).

In the fourth aspect of the invention, when the direct-current power supply (65) applies a direct-current voltage to the pair of electrodes (51, 52), streamer discharge is performed between the pair of electrodes (51, 52). Here, when a direct-current voltage is applied to the pair of electrodes (51, 52) as above, the leakage current between the pair of electrodes (51, 52) is larger than, e.g., when a pulse voltage is applied thereto, and thus, it becomes difficult to perform electrical discharge. To address this problem, the electrical discharge generator (50) of the fourth aspect of the invention includes the current density concentration member (55) configured to increase the current density between the pair of electrodes (51, 52). The current density concentration member (55) increases the current density during electrical discharge, and thus, also when the direct-current power supply (65) is used as a power supply, stable electrical discharge can be performed.

According to a fifth aspect of the invention, in the fourth aspect of the invention, the current density concentration member (55) may be formed as an insulative container having at least one opening (58), and may surround only one (51) of the pair of electrodes (51, 52).

In the fifth aspect of the invention, the current density concentration member (55) formed as an insulative container surrounds the electrode (51). The at least one opening (58) is formed in the current density concentration member (55). A current path is formed between the pair of electrodes (51, 52) to pass through the opening (58). The current path between the pair of electrodes (51, 52) is narrowed by the opening (58), and thus, the current density in the vicinity of the opening (58) is increased. As a result, stable streamer discharge is performed between the pair of electrodes (51, 52) through the opening (58) of the current density concentration member (55).

According to a sixth aspect of the invention, the medical device cleaning device of the fourth or fifth aspect of the invention may further include: a shield member (60) formed as a conductive net, grounded, and disposed around the pair of electrodes (51, 52) and the current density concentration member (55).

In the sixth aspect of the invention, the pair of electrodes (51, 52) and the current density concentration member (55) are surrounded by the shield member (60). The shield member (60) is formed as a conductive net. The shield member (60) is grounded. This prevents charge generated by the streamer discharge between the pair of electrodes (51, 52) from leaking to outside the shield member (60).

### ADVANTAGES OF THE INVENTION

According to the present invention, streamer discharge is induced in the wash water by applying a voltage to the pair of electrodes (51, 52) of the electrical discharge generator (50), and the medical device (100) in the washing tank (40) is cleaned by utilizing the hydrogen peroxide produced by streamer discharge in the wash water. Therefore, according to the present invention, a hydrogen peroxide solution does not need to be added from outside into the medical device cleaning device (10), and wash water containing hydrogen peroxide can be easily obtained. When streamer discharge is performed in the wash water, the rate of production of hydrogen peroxide is much higher than, e.g., when the wash water is electrolyzed. Therefore, according to the present invention, a large amount of hydrogen peroxide can be produced in a short time, thereby providing sufficient antimicrobial activity in a short time.

According to the third aspect of the invention, the direct-current power supply (65) is used as the power supply of the electrical discharge generator (50). This can provide a simpler power supply having a smaller size at lower cost than when a known pulse power supply is used. The use of such a pulse power supply tends to increase the intensity of a shock wave and noise in water due to electrical discharge; however, since, in the third aspect of the invention, the direct-current power supply (65) is used, this can reduce such a shock wave and noise.

Furthermore, according to the third aspect of the invention, the electrical discharge generator (50) includes the current density concentration member (55). Therefore, even when the direct-current power supply (65) is used as the power supply, stable streamer discharge can be performed in the wash water, and hydrogen peroxide can be stably produced.

According to the fourth aspect of the invention, the electrode (51) is surrounded by the current density concentration member (55) formed as a container, and the current path is narrowed by the opening (58) formed in the current density concentration member (55). This can increase the current density in the vicinity of the opening (58), and can provide more stable streamer discharge to ensure the production of hydrogen peroxide.

According to the fifth aspect of the invention, the pair of electrodes (51, 52) and the current density concentration member (55) are surrounded by the shield member (60), thereby preventing charge generated by the streamer discharge between the pair of electrodes (51, 52) from leaking to outside the shield member (60). Therefore, even when, during the progress of the streamer discharge, an operator touches cleaning fluid outside the shield member (60), the operator does not receive an electric shock, thereby improving the safety of the medical device cleaning device (10).

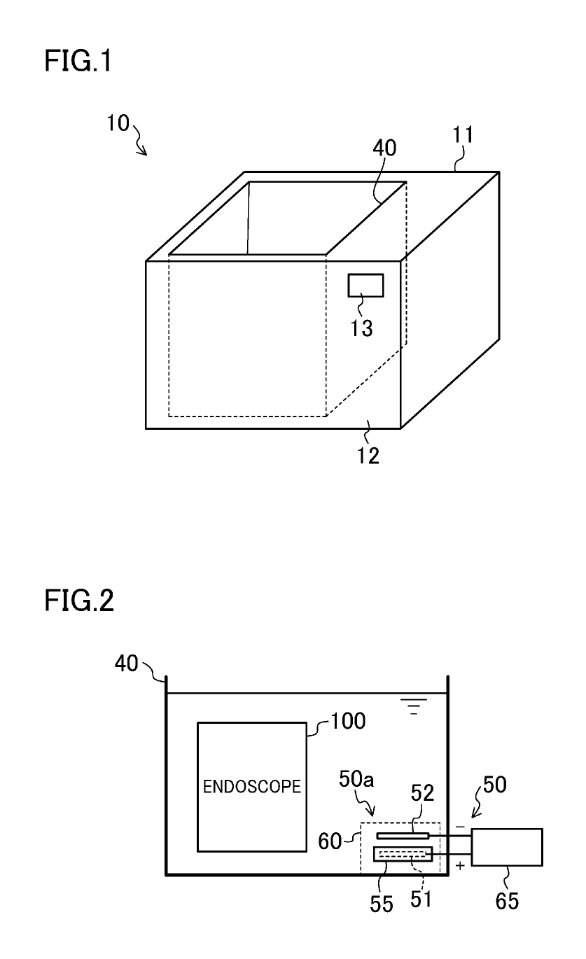

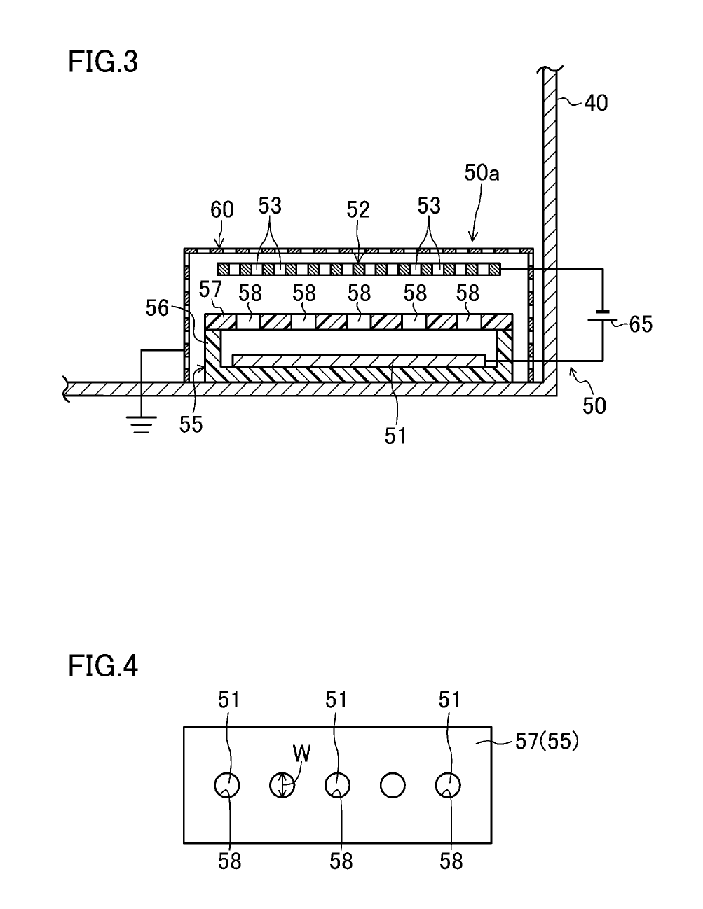

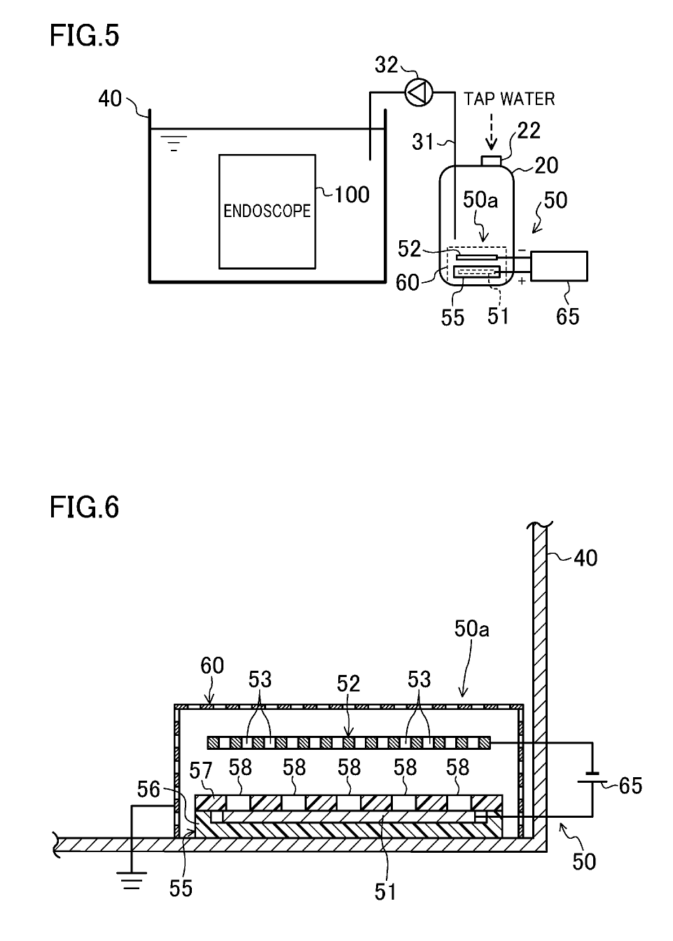

### BRIEF DESCRIPTION OF THE DRAWINGS

[FIG. 1] FIG. 1 is a perspective view illustrating a schematic structure of a medical device cleaning device according to a first embodiment.

[FIG. 2] FIG. 2 is a schematic block diagram of the medical device cleaning device according to the first embodiment.

[FIG. 3] FIG. 3 is an enlarged schematic block diagram illustrating an electrical discharge unit according to the first embodiment.

[FIG. 4] FIG. 4 is a top view of an insulation case.

[FIG. 5] FIG. 5 is a schematic block diagram illustrating a medical device cleaning device according to a second embodiment.

[FIG. 6] FIG. 6 is an enlarged schematic block diagram illustrating an electrical discharge unit according to another embodiment.

### DESCRIPTION OF EMBODIMENTS

Embodiments of the present invention will be described hereinafter in detail with reference to the drawings. The following embodiments are set forth merely for the purposes of preferred examples in nature, and are not intended to limit the scope, applications, and use of the invention.

<<First Embodiment Of The Invention>>

A first embodiment of the present invention will be described. A medical device cleaning device (10) according to this embodiment is configured to clean an endoscope which is a medical device (100). The medical device cleaning device (10) sterilizes an endoscope using wash water containing hydrogen peroxide (H₂O₂).

As illustrated in FIG. 1, the medical device cleaning device (10) includes a casing (11), and a washing tank (40) placed in the casing (11). The casing (11) is formed in the shape of a box having a substantial rectangular parallelepiped shape. A front surface (12) of the casing (11) includes an operation panel (13) for operating the medical device cleaning device (10). The washing tank (40) is a container having an open upper side and having a rectangular parallelepiped shape. The capacity of the washing tank (40) is set at a value which is large enough to accommodate an endoscope (e.g., about six liters). The washing tank (40) may have a hollow cylindrical shape having an open upper side.

As illustrated in FIG. 2, the medical device cleaning device (10) includes an electrical discharge generator (50). The electrical discharge generator (50) includes an electrical discharge unit (50a), and a direct-current power supply (65). The electrical discharge unit (50a) is placed in a portion of the washing tank (40) near the bottom thereof, and is immersed in wash water in the washing tank (40). The direct-current power supply (65) is disposed in the casing (11) and outside the washing tank (40).

As illustrated in FIG. 3, the e lectrical discharge unit (50a) includes a pair of electrodes (51, 52), an insulation case (55), and a shield member (60).

The pair of electrodes (51, 52) includes an electrical discharge electrode (51) and a counter electrode (52). The electrical discharge electrode (51) is a plate-shaped electrode. The counter electrode (52) is a mesh-like electrode having a plurality of holes (53). The counter electrode (52) may form a plate shape similar to that of the electrical discharge electrode (51). The electrical discharge electrode (51) and the counter electrode (52) are opposed to each other so as to be parallel to each other while being each maintained in a horizontal position.

The electrical discharge electrode (51) is connected to a positive terminal of the direct-current power supply (65), and the counter electrode (52) is connected to a negative terminal of the direct-current power supply (65). When a voltage is applied from the direct-current power supply (65) to the pair of electrodes (51, 52), streamer discharge is performed between the electrodes (51, 52). Thus, active species, such as hydroxyl radicals, are produced in the wash water, and furthermore, hydrogen peroxide is produced therein. The counter electrode (52) has the plurality of holes (53). This accelerates the diffusion of the hydrogen peroxide produced between the electrical discharge electrode (51) and the counter electrode (52) above the counter electrode (52).

The insulation case (55) is placed on the bottom of the washing tank (40). The insulation case (55) is an insulating member made of an insulating material, such as ceramic or the like. The insulation case (55) has a container member (56) and a lid member (57). The container member (56) is formed as a box having one opened side (upper side). The electrical discharge electrode (51) is laid on the bottom of the container member (56). The lid member (57) blocks the opened upper side of the container member (56).

The lid member (57) has a plurality of openings (58) vertically passing through the lid member (57). In other words, the plurality of openings (58) are formed in an upper portion of the insulation case (55) (near the counter electrode (52)). As illustrated also in FIG. 4, in this embodiment, five openings (58) are spaced at regular intervals. The number of the openings (58) is merely an example, and as long as at least one opening (58) is formed, the number of the openings (58) may be any number. The openings (58) are each circular. The width (diameter) W of each of the openings (58) is preferably greater than or equal to 0.02 mm and equal to or less than 0.5 mm.

While the electrical discharge electrode (51) is surrounded by the insulation case (55), the plurality of openings (58) are formed in the lid member (57) forming a portion of the insulation case (55). The insulation case (55) functions as a current density concentration member serving to increase the current density between the pair of electrodes (51, 52). Specifically, while the electrical discharge electrode (51) is surrounded by the insulation case (55), the current path during streamer discharge is narrowed by the plurality of openings (58). This increases the current density in the vicinity of each of the openings (58). This increases the amount of active species produced during streamer discharge and thus the amount of hydrogen peroxide produced.

A predetermined distance is kept between the electrical discharge electrode (51) and the lid member (57) in the insulation case (55). This improves the durability of the lid member (57). Specifically, when the electrical discharge electrode (51) and the lid member (57) are brought into close contact with each other, Joule heat incident to electrical discharge tends to melt or degrade the lid member (57). On the other hand, when a predetermined distance is kept between the electrical discharge electrode (51) and the lid member (57), this can reduce a sudden increase in the temperature of the lid member (57). Consequently, the melting or degradation of the lid member (57) due to electrical discharge is reduced.

The shield member (60) is disposed around the electrical discharge electrode (51), the counter electrode (52), and the insulation case (55). The shield member (60) is a grounded net-like cover made of metal. This prevents the flow of electrical discharge current through the outside of the shield member (60). Since the shield member (60) is net-like, hydrogen peroxide produced inside the shield member (60) diffuses to outside the shield member (60).

As illustrated in FIG. 2, in this embodiment, the electrical discharge unit (50a) is provided on the bottom of the washing tank (40). The wash water around the electrical discharge unit (50a) is heated by Joule heat incident to electrical discharge. This provides natural convection in the washing tank (40), and hydrogen peroxide produced by streamer discharge diffuses to the entire washing tank (40) by natural convection.

The direct-current power supply (65) forms a power supply serving to apply a high direct-current voltage to the pair of electrodes (51, 52). The power supply voltage of the direct-current power supply (65) is set to several kilovolts or lower (e.g., 7 kV or lower). As such, since the power supply is the direct-current power supply (65), this can provide a simpler power supply having a smaller size at lower cost than when the power supply is, e.g., a pulse power supply serving to apply a pulse voltage. Such a pulse power supply tends to cause a shock wave and noise in water due to electrical discharge; however, when the power supply is the direct-current power supply (65), such a shock wave can also reduce noise generation.

In contrast, when the direct-current power supply (65) is used, the discharged power tends to be lower than when a pulse power supply is used. However, when the current density during electrical discharge is increased by the insulation case (55), a sufficient amount of active species can be produced even with a relatively low discharged power.

Incidentally, unlike the pulse power supply, the direct-current power supply (65) does not serve to instantaneously apply a large voltage, and thus, tends to increase the leakage current between the pair of electrodes (51, 52). However, when the electrical discharge electrode (51) is surrounded by the insulation case (55), this reduces the leakage current, resulting in an increase in the current density in the current path through each of the openings (58). Joule heat is generated in the opening (58) due to an increase in the current density, and thus, water in the opening (58) is vaporized to form bubbles. The bubbles function as resistances for reducing the leakage current between the pair of electrodes (51, 52). In view of the above, in the electrical discharge generator (50) of this embodiment, the leakage current between the pair of electrodes (51, 52) is minimized. This ensures a desired potential difference between the pair of electrodes (51, 52), and thus, streamer discharge is performed. The streamer discharge is performed in bubbles formed in the vicinity of the openings (58).

The electrical discharge generator (50) includes a constant power controller (not shown) for controlling the discharged power during streamer discharge to a constant power. Such a constant power control enables streamer discharge at a constant discharged power even with a change in the electrical conductivity of the wash water due to the influence of, e.g., operation conditions. This can prevent the consumed power from being increased due to an excessively high discharged power under relatively high electrical conductivity, and furthermore, can prevent the amount of hydrogen peroxide produced from excessively decreasing due to an excessively low discharged power under relatively low electrical conductivity.

Although not shown, the medical device cleaning device (10) includes a controller configured to control operation of the entire medical device cleaning device (10). The controller includes, for example, a CPU, a ROM in which a control program executed by the CPU, and various data are stored, and a RAM which serves as a work area, and in which measurement data and various data are temporarily stored.

—Operational Behavior—

The operational behavior of the medical device cleaning device (10) will be described.

An endoscope to be cleaned is housed in the washing tank (40) by a user. When operation of the medical device cleaning device (10) is subsequently started, tap water is fed, as wash water, into the washing tank (40). When the water level in the washing tank (40) rises, and the electrical discharge unit (50a) is immersed in the wash water, a voltage starts being applied from the direct-current power supply (65) to the pair of electrodes (51, 52). A voltage only needs to start being applied to the pair of electrodes (51, 52) after the electrical discharge unit (50a) is immersed in the wash water, and may start being applied thereto either before or after the water level in the washing tank (40) reaches the highest water level.

When a voltage is applied to the pair of electrodes (51, 52), streamer discharge proceeds from the electrical discharge electrode (51) to the counter electrode (52). In this case, the electrical discharge path is narrowed between the pair of electrodes (51, 52) by each of the openings (58) of the insulation case (55), and thus, the current density in the vicinity of the opening (58) increases. This enables the production of a high concentration of active species in the wash water in the washing tank (40).

When active species, such as hydroxyl radicals, are produced in the wash water, the active species react with water molecules to produce hydrogen peroxide. As a result, wash water having a desired hydrogen peroxide concentration is obtained in the washing tank (40). The electrical discharge generator (50) operates to adjust the hydrogen peroxide concentration in the wash water in the washing tank (40). In other words, in the operation of the electrical discharge generator (50), the hydrogen peroxide concentration in the wash water is detected with a sensor, and the direct-current power supply (65) is turned on or off to allow the detected hydrogen peroxide concentration to be closer to a predetermined target value, or the power output from the direct-current power supply (65) to the pair of electrodes (51, 52) is controlled.

When the water level in the washing tank (40) reaches the highest water level, the wash water in the washing tank (40) is stirred with an agitator outside the drawings. Then, the endoscope is sufficiently sterilized by stirring the wash water in the washing tank (40) for a predetermined time. During this sterilization, the electrical discharge generator (50) continuously operates to adjust the hydrogen peroxide concentration in the wash water in the washing tank (40) to maintain a target hydrogen peroxide concentration in the wash water. In addition to or instead of the agitator, an ultrasonic transducer may be placed in the washing tank (40) to enhance the cleaning effect with ultrasound. With the completion of the cleaning of the endoscope (100), the medical device cleaning device (10) discharges the wash water from the washing tank (40), and then stops.

—Advantages of First Embodiment—

In this embodiment, the pair of electrodes (51, 52) of the electrical discharge generator (50) are provided while being immersed in the wash water, and the endoscope (100) in the washing tank (40) is cleaned by utilizing hydrogen peroxide produced by streamer discharge in the wash water. Therefore, according to this embodiment, a hydrogen peroxide solution does not need to be added from outside into the medical device cleaning device (10), and wash water containing hydrogen peroxide can be easily obtained.

When streamer discharge is performed in the wash water, the rate of production of hydrogen peroxide is much higher than, e.g., when the wash water is electrolyzed. Specifically, when the streamer discharge is performed in the wash water, the rate of production of hydrogen peroxide is about 10 times as high as that when the wash water is electrolyzed. Therefore, according to this embodiment, a large amount of hydrogen peroxide can be produced in a short time, thereby providing sufficient antimicrobial activity in a short time.

In this embodiment, the direct-current power supply (65) is used as a power supply of the electrical discharge generator (50). This can provide a simpler power supply having a smaller size at lower cost than when a known pulse power supply is used. The use of a pulse power supply tends to increase the intensity of a shock wave and noise generated in water due to electrical discharge. In contrast, in this embodiment, the use of the direct-current power supply (65) can reduce the intensity of such a shock wave and such noise.

In this embodiment, the electrical discharge electrode (51) is surrounded by the insulation case (55), and the current path is narrowed by each of the openings (58) formed in the the insulation case (55). This can increase the current density in the vicinity of the opening (58), and can further stabilize streamer discharge to ensure the production of hydrogen peroxide.

Furthermore, in this embodiment, the electrical discharge electrode (51), the counter electrode (52), and the insulation case (55) are surrounded by the shield member (60), and thus, the electrical discharge current flowing between the electrical discharge electrode (51) and the counter electrode (52) does not leak to outside the shield member (60). Therefore, even when, during the progress of the streamer discharge, an operator touches cleaning fluid outside the shield member (60), the operator does not receive an electric shock, thereby improving the safety of the medical device cleaning device (10).

<<Second Embodiment of the Invention>>

A second embodiment of the present invention will be described. Here, differences between a medical device cleaning device (10) according to this embodiment and the medical device cleaning device (10) according to the first embodiment will be described.

As illustrated in FIG. 5, the medical device cleaning device (10) according to this embodiment further includes an auxiliary tank (20), a water feed conduit (31), and a water feed pump (32). Although not shown, the auxiliary tank (20), the water feed conduit (31), and the water feed pump (32) are housed in the casing (11). In the medical device cleaning device (10), an electrical discharge unit (50a) is disposed not in a washing tank (40), but in the auxiliary tank (20).

The auxiliary tank (20) is formed as a vertically oriented hollow cylindrical container. A feed water inlet (22) through which tap water is introduced into the auxiliary tank (20) is formed in a top portion of the auxiliary tank (20). The electrical discharge unit (50a) is housed in the auxiliary tank (20). The electrical discharge unit (50a) is disposed in the vicinity of the bottom of the auxiliary tank (20).

The water feed conduit (31) forms a conduit through which wash water is carried from the auxiliary tank (20) into the washing tank (40). The water feed conduit (31) is formed by a flexible tube made of, for example, a fluorocarbon resin material or a silicon material, or a pipe made of metal. An inlet end of the water feed conduit (31) is open in the vicinity of the bottom of the auxiliary tank (20). In contrast, an outlet end of the water feed conduit (31) is open in the washing tank (40). The water feed pump (32) is provided within the water feed conduit (31). The water feed pump (32) discharges wash water drawn from the auxiliary tank (20) into the washing tank (40).

—Operational Behavior—

During operation of the medical device cleaning device (10), tap water is fed, as wash water, into the auxiliary tank (20), and a voltage is applied from a direct-current power supply (65) to a pair of electrodes (51, 52). Streamer discharge is performed between the pair of electrodes (51, 52) immersed in the wash water in the auxiliary tank (20) to produce hydrogen peroxide. When the water feed pump (32) is operated, wash water containing hydrogen peroxide is fed from the auxiliary tank (20) through the water feed conduit (31) into the washing tank (40).

During the cleaning of an endoscope, the medical device cleaning device (10) operates to adjust the hydrogen peroxide concentration in the wash water in the washing tank (40). For example, the medical device cleaning device (10) operates to turn the water feed pump (32) or the direct-current power supply (65) on or off to allow the hydrogen peroxide concentration detected with a sensor to be closer to a predetermined target value, or operates to adjust the rotational speed of the water feed pump (32) and the power output from the direct-current power supply (65).

<<Other Embodiments>>

In each of the embodiments described above, the following configurations may be used.

<Type of Wash Water>

While, in each of the embodiments described above, streamer discharge is performed in tap water serving as wash water to produce hydrogen peroxide, a saline solution (an aqueous sodium chloride solution) may be used as the wash water, and streamer discharge may be performed in the saline solution. When streamer discharge is performed in a saline solution, hydrogen peroxide is produced by streamer discharge, and simultaneously, a saline solution (water to be electrolyzed) is electrolyzed to produce hypochlorous acid (HClO). The hypochlorous acid shows greater bacteriocidal acitivity than hydrogen peroxide, and thus, antimicrobial activity is expected to be enhanced.

<Configuration of Electrical Discharge Unit>

In each of the embodiments described above, the constant power controller is used to control the discharged power during streamer discharge to a constant power. However, instead of the constant power controller, a constant current controller can be provided to control the discharged current during streamer discharge to a constant current. The control of the discharged current to a constant current allows electrical discharge to be stable independently of the electrical conductivity of the wash water, thereby preventing sparks.

In each of the embodiments described above, the electrical discharge electrode (51) is connected to the positive terminal of the direct-current power supply (65), and the counter electrode (52) is connected to the negative terminal of the direct-current power supply (65). However, so-called negative discharge may be performed between the electrodes (51, 52) by connecting the electrical discharge electrode (51) to the negative terminal of the direct-current power supply (65), and connecting the counter electrode (52) to the positive terminal of the direct-current power supply (65).

In each of the embodiments described above, as illustrated in FIG. 6, the insulative lid member (57) and the electrical discharge electrode (51) may be in contact with each other. This configuration can also increase the current density in the vicinity of each of the openings (58) of the lid member (57). Therefore, stable streamer discharge is performed, thereby accelerating the rate of production of hydrogen peroxide.

<Medical Device To Be Cleaned>

In each of the embodiments described above, the endoscope (100) is a medical device to be cleaned; however, the medical device to be cleaned is not limited to the endoscope (100). For example, surgical instruments, such as forceps, attached to a robot arm of a surgical robot, or a nebulizer for use in a mechanical ventilator, a humidifier, or a thermometer may be a medical device to be cleaned. Examples of the endoscope (100) include a laryngeal endoscope, a colonoscope, a peritoneoscope, and a salpingoscope.

### INDUSTRIAL APPLICABILITY

As described above, the present invention is useful for medical device cleaning devices configured to clean a medical device, such as an endoscope.

### DESCRIPTION OF REFERENCE CHARACTERS

10 MEDICAL DEVICE CLEANING DEVICE
20 AUXILIARY TANK
31 WATER FEED CONDUIT (CONDUIT)
40 WASHING TANK
51 ELECTRICAL DISCHARGE ELECTRODE (PAIR OF ELECTRODES)
52 COUNTER ELECTRODE (PAIR OF ELECTRODES)
55 INSULATION CASE (CURRENT DENSITY CONCENTRATION MEMBER)
60 SHIELD MEMBER
65 DIRECT-CURRENT POWER SUPPLY (POWER SUPPLY)
100 ENDOSCOPE (MEDICAL DEVICE)

1. A medical device cleaning device, comprising:
a washing tank for housing a medical device, the medical device in the washing tank being cleaned with wash water, wherein
an electrical discharge generator including a pair of electrodes for inducing streamer discharge in the wash water, and a power supply configured to apply a voltage to the pair of electrodes is provided to produce hydrogen peroxide in the wash water by streamer discharge between the pair of electrodes, and
the medical device in the washing tank is cleaned with the wash water containing the hydrogen peroxide produced by the streamer discharge between the pair of electrodes.

2. The medical device cleaning device of claim 1, wherein the pair of electrodes of the electrical discharge generator is placed in the washing tank.

3. The medical device cleaning device of claim 1 further comprising:
an auxiliary tank in which the wash water is stored, and in which the pair of electrodes of the electrical discharge generator are placed; and
a conduit configured to carry the wash water containing the hydrogen peroxide from the auxiliary tank into the washing tank.

4. The medical device cleaning device of claim 1, wherein
the power supply is formed by a direct-current power supply configured to apply a direct-current voltage to the pair of electrodes, and
the electrical discharge generator includes a current density concentration member configured to increase a current density in a current path between the pair of electrodes.

5. The medical device cleaning device of claim 4, wherein the current density concentration member is formed as an insulative container having at least one opening, and surrounds only one of the pair of electrodes.

6. The medical device cleaning device of claim 4, further comprising:
a shield member formed as a conductive net, grounded, and disposed around the pair of electrodes and the current density concentration member.
